(19) United States
(12) Patent Application Publication
(10) Pub. No.: US 2017/0215444 A1
(43) Pub. Date: Aug. 3, 2017

(54) COMPOSITION AND PROCESS FOR OBTAINING PEELED PRICKLY PEARS COATED WITH AN EDIBLE FILM BASED ON CELLULOSE DERIVATIVES

(71) Applicant: Universidad de Santiago de Chile, Santiago (CL)

(72) Inventors: Laura del Carmen Almendares Calderón, Santiago (CL); José Manuel Román Miranda, Santiago (CL)

(21) Appl. No.: 15/369,333

(22) Filed: Dec. 5, 2016

(30) Foreign Application Priority Data
Feb. 3, 2016 (CL) 0277-2016

(51) Int. Cl. A23B 7/16

(52) U.S. Cl. CPC A23B 7/16; A23V 2002/00

(57) ABSTRACT

The present invention is related to a composition to obtain peeled prickly pears coated with an edible film based on cellulose derivatives; process to obtained peeled prickly pears with the cellulose derived edible composition; and its use to coat the peeled prickly pears to delay the fruit dehydration and decomposition.

### CROSS-REFERENCE TO RELATED APPLICATIONS

This application claims the benefit of co-pending Chilean Patent Application Serial No. CL 0277-2016, filed 3 Feb. 2016, which is hereby incorporated herein as though fully set forth.

### FIELD OF THE INVENTION

The present invention is related to providing a process, a composition, and its use to obtain peeled fruits coated with an edible film based on cellulose derivatives. More specifically, the present invention provides a process, a composition, and its use to coat peeled fruits; for example, peeled prickly pear, delaying their dehydration and decomposition maintaining the biochemical processes from the fresh fruit.

### BACKGROUND OF THE INVENTION

Nowadays, the existence of edible coatings for fruit species with skin or peel to preserve dehydration and decomposition to increase their shelf life by preserving these conditions is known. Furthermore, some attempts have been made to obtain coating for peeled fruits or chopped vegetables with no success.

Nevertheless, in the know literature there are no associated disclosures or hints disclosing a process to coat peeled fruits that further comprises to apply an edible coating composition to a fruit once the skin or peel (peeled) has been removed, which also successfully maintain its organoleptic characteristics, over a long period of time. In this invention the edible coating composition has been designed to be applied to a fruit without its skin or peel, e.g. a prickly pear. The fruit keeps breathing, wherein said coating composition acts as a barrier to prevent the entry of decay microorganisms. This coating helps to regulate the gas exchange from the fruit breathing as well as the transpiration rate (dehydration). This is achieved by a process with specially designed steps, wherein some of these are to sanitize the product, to apply a sterile edible coating composition and its use to coat peeled prickly pears. In the prior art, the use of HPMC in the manufacturing of edible coatings, and the combination of cellulose ethers, such as HPMC, to obtain edible coating is known. Also, in some disclosures the application of a composition to coat fruits with skin or peel, by the use of brushes is known.

Document WO 2015104440 was also found as part of the state of the art. This document describes a coating composition for the preservation of fruits. The application claimed an aqueous solution comprised of carboxymethylcellulose (1 to 0.75% w/w), a source of calcium (calcium ascorbate 3 to 15%), an antioxidant agent and optionally, an antimicrobial agent (Malic acid). The elements that partially overlap the present invention are the technical problem to solve, which is coating fruit with an edible composition, wherein the claimed composition comprises carboxymethylcellulose, which is an ether of cellulose. However, this document does not mention that it is applied to the skinless or peeled fruits.

Another example is the patent No. ES 202040330, which claims an edible composition to coat dried fruits. The composition aims to protect the fruit, maintaining its organoleptic characteristics. The formulation comprises HPMC, HPC, MC, CMC, EMC, gum arabic, maltodextrin, and a lipid.

Document WO 2014153210 describes a coating to be applied over vegetables, plants, part of plants, seeds, and fruits. The coating should not significantly alter the food's appearance and organoleptic characteristics. The set of claims claimed a composition comprised of cellulose nanoparticles (nanofibrils, nanocrystals and/or combinations), an inorganic salt and a crosslinking agent.

Document U.S. Pat. No. 6,723,342 describes an edible composition, for pharmaceutical use, veterinary use, seed coating, food coating, among others. The composition contains mycrocrystalline cellulose, carrageenan and at least a hardening polymer. The composition is hydrated and applied as a spray on the element to be coated.

Document WO 2013049928 describes an edible composition to preserve the organoleptic characteristics of a food product that undergoes a thermal treatment, suitable to be applied on fruits, vegetables, meat, and fish. This document disclosed a composition containing a polysaccharide (carrageenan, gellan gum, sodium alginate, pectin) in a range from 0.1 to 15%, a hardening agent (calcium ascorbate) between 0.5 and 50%, an antioxidant agent and an antimicrobial.

Document EP 1010368 A1 describes a composition and a process to store fruits and vegetables. The composition comprises L-ascorbic acid, citric acid (20-60% w/v) and calcium chloride, wherein the process comprises the immersion of the fruit or vegetable in the solution, and then drying the solution by centrifugation. Finally the fruits and vegetables are packaged in reduced oxygen atmospheres. This document is different from the present invention in that the solution does not contain HPMC or other polysaccharides; it does not use glycerol, and the solutions are not sterilized prior to its use. Furthermore, the composition and processes are applied over fruits and vegetables with their peel. On the other hand, the present invention uses a lower concentration of citric acid (0.5-3% w/v).

Document U.S. Pat. No. 2,615,814 describes a liquid composition to treat the surface or fruits and vegetables without skin or peel. The composition comprises 8-hydroxy-quinoline and a member of the group comprises lecithin and choline. This document is different from the present invention in that the composition does not contain HPMC or other polysaccharides, does not comprise citric acid, does not use glycerol, and the solutions are not sterilized or sanitized before its use. Furthermore, it does not mention how the composition is applied to the fruit nor how the packaging is performed after the coating.

On the other hand, document U.S. Pat. No. 4,988,523 describes a composition and a process to store fresh fruit without skin or peel and leafless vegetables. The composition comprises an acid polyphosphate compound and citric acid (0.5-2% w/v), wherein the process comprises the immersion or aspersion of the fruit in the composition to preserve them from oxidation and discoloration. Finally, the fruits and vegetables are stored under refrigeration at temperatures between 0 and 5° C. This document is different from the present invention in that the solution does not contain HPMC or other polysaccharides, it does not use glycerol and the solutions are not sterilized before its use.

Document U.S. Pat. No. 6,749,875 describes a process to extend the duration of peeled or chopped fruits and vegetables. The process comprises the steps of preparing an aqueous solution containing flavonoids associated with antioxidants and applying this solution by immersion, aspersion, or bath, wherein the peeled or chopped fruits and vegetables are finally stored. This document is different from the present invention in that the composition does not contain HPMC or other polysaccharides, it does not use glycerol, it does not contain citric acid, and the solutions are not sterilized before its use.

Document WO 94/12041 describes a method to preserve fruits and vegetables to maintain their natural appearance. The method comprises the immersion of the fruit or vegetable in an aqueous solution containing sodium and/or potassium ions, calcium ions, chloride ions, ascorbic acid and citric acid. This document is different from the present invention in that the solution does not contains HPMC or other polysaccharides, does not uses glycerol, does not specify the citric acid concentrations, and the solutions are not sterilized before its use. Moreover, it is not mentioned how the packaging and storing of the fruits after the coating are performed.

The non-patent document “Efecto del recubrimiento de películas comestibles de quitosanosobre tuna rojalista para el consumo” written by Ochoa, C. E., 2011, describes the effect of coating red prickly pear previously peeled with edible films of chitosan. It mentions the process steps used to perform the coating as well as the analysis performed to the fruit in base to its physicochemical, microbiological and antioxidant characteristics. This document is different from the present invention in the prickly pears coating process, as it does not have the fundamental steps that allow the development of this new technology. It is also different from the present invention in the composition used to coat the peeled prickly pears. The document uses the polysaccharide Poli-D-glucosamin (Chitosan), while the present invention uses the polysaccharide Hydroxypropyl methylcellulose (HPMC). Chitosan (C₅₆H₁₀₃N₉O₃₉) is compounded by monosaccharides of the D-glucosamine molecule, which are repeated n times and are linked by β-(1-4) bonds randomly distributed. On the other hand HPMC (C₅₆H₁₀₈O₃₀), is a polymer from a saccharide synthesized from cellulose, in which disaccharides are repeated n times linked by β-(1-4) bonds. Furthermore, the substituents in the monosaccharide cycle in the main chain are different in each case. For example, chitosan has an amine radical [—NH₃+] in carbon 2. In a different way, HPMC has 2 hydroxyl [—OH] in its carbon 2. These structural differences allow us to conclude that the coating process, the disclosed composition, and its used in peeled prickly pears referred by the present invention are novel.

None of the previous art documents, in the patent literature as well as in the non-patent literature, disclose a process to coat a skinless or peeled fruit by the application of a sterile edible composition, delaying the dehydration and decomposition of the peeled fruit, maintaining the fresh fruit characteristics for longer time.

### DESCRIPTION OF THE INVENTION

The demand for prickly pears is diminished because of the difficulty related to the skin removal, which when removed produces puncture wounds in the hands from the remaining thorns left over from the previous step of thorn removal. The producers are small farmers whose soils despite being poor are appropriate for the production of this species, which requires little water for irrigation. A greater demand for the fruit, could increase the planted areas, and thus their income. The opportunity is backed by the recent increase in demand on the international market for the fruit and a higher national demand among the upper income bracket for “ready to eat fruit”, a characteristic present in the fruit processed according to the novel technique developed by this invention; and that in addition has achieved and extension of the shelf life of the treated peeled fruits which are maintained in a fresh state for of 30 to 45 days in refrigerated conditions and modified atmosphere. The untreated product has a shelf life of only 8 to 10 days.

Ripe (ripe for consumption), thorn free, washed, and sanitized by the application of disinfectant product approved by the Sanitary Regulations for Food, prickly pears are used. Fruits are peeled, disinfected again, and an edible coating is applied to them. The compound films are formulated by the combination of hydrocolloids and lipids, allowing for taking functional advantage of both, decreasing the unfavorable characteristics. Hydrocolloids composed by polysaccharides are used, particularly those based on cellulose, as they form part of most of the formulations that currently exist in the market. While there are several derivatives obtained by chemical modifications of natural cellulose, only a few cellulose ethers have been found useful in the food industry. Most commonly used derivatives are carboxymethylcellulose, methylcellulose, and hydroxypropyl methylcellulose. These last two are used because of their capacity to form thermoreversible gels and their interfacial properties. To coat the peeled prickly pears in the present invention, hydroxypropyl methylcellulose (HPMC) was used, which in addition to coating the food and forming a film over the fruit itself, is biodegradable, renewable, flexible, and does not add flavors or foreign smells to the food because it is a cellulose derivative, which makes it a viable option in time, as it also improves the mechanical barriers by being versatile, water soluble, and oxygen permeable. The humidity excess is carefully eliminated and they are packed in bags with partial barriers for CO₂ and O₂. They are stored in a modified atmosphere (MA) with refrigeration at 2-4° C.

There is no technology worldwide comprising a coating process of peeled prickly pears by means of a sterile edible composition, therefore the product is not on the market. Finally, the present invention provides a thorn free product, fresh for a long period of time and ready for consumption. The international market and a segment of the national market have become accustomed to “ready to eat” fruit, therefore offering them will increase the demand. The higher demand will bring an interest to increase plantations. This will result in the use of less productive soils, not unsuitable for other crops, and additionally the water requirement of this species is smaller, hence the water shortage is not a problem. This advantage is especially valid for the small and medium rural agriculture.

### DETAILED DESCRIPTION OF THE INVENTION

To carry out this invention, it is necessary to prepare the edible composition under sterile conditions, whose components are hydroxypropyl methylcellulose (HPMC) in solution, which is a cellulose ether in which about ⅓ corresponds to hydroxyl groups, HPMC being the most hydrophilic of the methylcelluloses, glycerol and citric acid.

To perform the production process the following steps are considered:
1. To harvest the prickly pears in state ripe for consumption, in order to later remove the thorns from the prickly pears.
2. To select the prickly pears, separating the damaged units.
3. To calibrate the prickly pears by size, so all of them have the same volume, allowing to control the amount of prickly pears that enter to the process, calculate the necessary supplies, and to obtain a final homogeneous product.
4. To wash the prickly pears using sanitizers to avoid the entrance of the bacteria or other organisms affecting the fruit decay;
5. To peel or remove the skin of the prickly pears.
6. To perform a second sanitization of the peeled prickly pears.
7. To apply the coating solution, that has been prepared under sterile conditions.
8. To dry the prickly pears to eliminate the residual surface humidity.
9. To pack the prickly pears individually in packages with a specific barrier to CO₂ and O₂, replacing the natural atmosphere by a composition of different gases (modified atmosphere).
10. To store the prickly pears already packaged in a refrigerated environment.

### Parameters and Conditions

In the process to coat fruits, such as a peeled prickly pears, is possible to delay their dehydration and decomposition, maintaining their biochemical processes as if they were fresh fruit.
1. Visual Inspection and selection: The skin color is a maturity index, which in this case corresponds to a slightly yellowish green coloration. This level of maturity that can be characterized as “firm”, in which the fruit already presents the appropriate organoleptic characteristics for consumption, but keeps a compact texture, without softened areas, especially in the bottom part, opposite to the apical end, tolerates well the mechanical handling and the thorns can be remove without it suffering physical damage. By being peeled, the fruit maintains the integrity of the pulp structure, which is firm and compact, but tender. Later the thorn removal is performed by rubbing the fruits with a surface able to remove the thorns not damaging the skin. Generally is a relatively rough fabric. This process can be performed manually with brooms, or automated. Once the thorns have been removed, they are separated by means of an air stream.
2. Raw material selection: it is done by visual inspection, separating the fruits presenting damage, deformities, excess of maturity, over ripped areas, etc.
3. Calibration: is performed in a mechanical manner, using the equatorial diameter as reference. Depending on the variety, the fruits are grouped as small, medium and large to be separately process. The selection by size is important for the packaging of the final product.
4. Washing and disinfection: are performed by water showers with the addition of sanitizer and brushing using rotating roll systems, comprised of soft bristles, until the dirt has been completely removed from the skin surface. This is necessary to avoid the transference of microorganism to the surface of the pulp during the peeling stage. The sanitizers used are sodium hypochlorite, and a solution containing hypochlorous acid, hypochlorite ions, and chloride dioxide. The solutions are each applied for two minutes in a separate sequential manner.
5. Peeling: consists in cutting the ends of the fruit and performing a longitudinal cut of the skin, to later remove it from the pulp, completely separating it.
6. Second disinfection of the peeled fruits: is performed using the disinfectant formulations that have demonstrated efficacy eliminating the microbiological contamination that may have remained from the peeling operation. The sanitizer used is sodium hypochlorite, and a solution containing hypochlorous acid, hypochlorite ions, and chloride dioxide. The solutions are each applied for two minutes in a separate sequential manner.
7. Sterilization of the coating solutions and application of the sterilization is performed in an alternative way by means of pasteurization at 80° C. or exposure to UV radiation, among other options, to eliminate the microbiological contamination. The application of the edible coating is performed at room temperature under sterile conditions, wherein the prickly pears without skin or peel are put in contact with the edible composition.

The coating can be apply in three manners; these are immersion, aspersion or casting. The immersion process consists of the application of the edible matrixes submerging the food in the coating solution. The aspersion process is a technique based on the application of the pressurized coating solution. This allows for a fine and uniform coating. Finally, casting consists in the obtaining of a uniform dispersion made of biomolecules, plasticizers, and water. It is then poured over a plate made of inert material (stainless steel) wherein it is let to dry to allow the film form.
8. The drying is done by air stream to evaporate the remnant water on the fruits when applying the coating solutions.
8. The packaging is performed using packages with a specific barrier to CO₂ and O₂ (Bags B-2620 from Sealedair). The normal atmosphere is replaced by a modified atmosphere, decreasing the content of O₂ to 3-5% and increasing the content of CO₂ to 2-3%.
8. The refrigerated storage is made at 2-4° C. for a period of 30 to 45 days.

### Sanitizing Solution Composition:

The process requires the use of sanitizer products in a two-step process. The prickly pear is sanitized when it has the peel as well as when it has been peeled. In each step of the sanitization process two solutions are used. The first solution is made of 150-200 ppm of sodium hypochlorite. The second solution is made of 170 ppm of hypochlorous acid, 25 ppm hypochlorite ions, and 700 ppm chlorine dioxide. The prickly pears are submerged in both solutions for 2 minutes each.

### Coating Solution Composition:

The components of this solution are 2-5% w/v solution of hydroxypropyl methylcellulose (HPMC), 0.5-3% w/v of glycerol and 0.5-3% w/v of citric acid; this later with the objective of delaying the darkening of the prickly pears under study. Furthermore, this coating solution once is dry, forms a tasteless, odorless and colorless film, which maintains the fruit's own characteristics.

### Examples

### Example 1: Preparation of the Edible Coating Composition

The selection of the coating that presented the best properties and results regarding the microbiological contamination of the prickly pears was based on studies performed before the present invention. The selected coating was based on 2-5% w/v of microcrystalline hydroxypropyl methylcellulose (HPMC). The preparation of the HPMC consisted in the dissolution of the solute in distilled water previously sterilized, with the addition of 0.5-3% w/v of glycerol, at a temperature of 80° C. for 30 minutes, using a magnetic agitator. At the same time a solution of 0.5-3% w/v of citric acid was prepared, which was incorporated to the solution of HPMC-glycerol. The use of citric acid has the objective of delaying the darkening of the prickly pears.

### Selection of the Proper Disinfectant as Preventive Treatment.

Sodium hypochlorite, hypochlorous acid, hypochlorite ions, and chloride dioxide solutions were used as disinfectants on the prickly pears and the used distilled water, to later coat the prickly pear with a coating solution based on HPMC. These disinfectants were prepared in the following concentrations: 200 ppm sodium hypochlorite, which was prepared with 16 mL of sodium hypochlorite in 4 L of distilled water, and a solution of 170 ppm of hypochlorous acid, 25 ppm hypochlorite ion and 700 ppm of chloride dioxide.

### Example 2: Coating of Peeled Prickly Pears with the Edible Coating Solution

100 kilograms of prickly pears were harvested, using the skin color as a maturity index, which in this case is a slightly yellowish green coloration. The thorns of these prickly pears were then removed by rubbing the fruits. The thorn removal was performed manually with brooms and/or automated, obtaining losses of 0.5 kilograms. Once the thorns were detached, these were removed by an air stream. The remnant of the raw material, 99.5 kg, was stored at temperatures of 2 to 4° C. and then was selected by visual inspection, separating the fruits presenting damage, deformations, excess of ripeness, over ripe areas, etc. After this, the raw material was mechanically calibrated, using the equatorial diameter as reference. Depending on the variety the fruits were grouped in small, medium and large caliber to be separately process.

After that, the prickly pears without thorns were disinfected with a 150-200 ppm sodium hypochlorite solution, by means of showers with water with added disinfectant, as well as brushing the fruit using a rotating rolls system comprised of soft bristles, until the dirt adhered to the surface of the skin has been completely removed. After this step, the damaged fruits were eliminated, losing 5 kg. The remaining 94.5 kg of fruits were separated in similar size batches.

Subsequently, the fruit peeling was performed, in which 94.5 kg of prickly pears were manually or mechanically peeled. In this stage a loss of 29 kg was obtained. The amount of raw material, 65.5 kg of peeled prickly pears, were disinfected a second time with a 0.02% w/v sodium hypochlorite, 0.07% w/v hypochlorous acid solution, and a solution made by three disinfectants: 170 ppm hypochlorous acid, 25 ppm hypochlorite ions, and 700 ppm chloride dioxide, to later apply the coating composition. The coating composition used is a mycrocrystallinehydroxypropyl methylcellulose solution assayed in the concentration range of 2-5% w/v, citric acid assayed in the range of 0.5-3% w/v, and glycerol assayed in the concentration range of 0.5-3% w/v, all dissolved in sterile water. Following this step, a dry air stream was applied to evaporate the excess of water from the fruit surface.

Finally, the peeled and coated with HPMC 2-5% v/v prickly pears were individually packaged in Sealedair B-2620 bags, replacing the normal atmosphere by a modified atmosphere, decreasing the content of Otto 3-5% and increasing the content of CO₂ to 2-3%.

### Example 3: Breathing Analysis

For all the treatments performed, the breathing analysis consisted of the measurement of gases (O₂ and CO₂) to observe the behavior of the packaged fruit in the barrier bags to these gases, in order to compare the respiratory activity with that of the untreated fresh fruit, expecting to obtain a decrease in the level of O₂ and an increase in the level of CO₂. The results indicated that the fruit continued breathing at a moderate rate, where the percentage of oxygen was reduced and the percentage of carbon dioxide increase in the interior of the package. The average value of all the samples in each treatment can be seen in table No. 1:

TABLE N^{o} 1
Data on breathing assessments

| | Chlorine + | | | | | | | | | |
|---|---|---|---|---|---|---|---|---|---|---|
| | hypochlorous | | | | | | | | | |
| | acid, | | | | | | | | | |
| | hypochlorite | | | | Hypochlorous | | | | | |
| | ions, | | | | acid, hypochlorite | | | | | |
| | and chloride | | | | ion and | | | | | |
| | dioxide | | Chlorine | | chloride dioxide | | Environment | | Control | |
| Days | CO₂% | O₂% | CO₂% | O₂% | CO₂% | O₂% | CO₂% | O₂% | CO₂ | O₂ |
| 5 | 5.46 | 13.16 | 1.96 | 19.06 | 9.41 | 6.51 | 0.24 | 20.05 | 8.32 | 11.34 |
| 10 | 6.37 | 9.92 | 0.6 | 18.78 | 14.9 | 3.47 | 0.39 | 20.21 | 13.87 | 4.71 |
| 15 | 8.39 | 8.49 | 0.4 | 17.85 | 14.73 | 3.47 | 0.42 | 20.2 | 16.23 | 3.79 |
| 20 | 9.41 | 6.51 | 5.9 | 15.84 | 17.61 | 0.26 | 0.43 | 20.19 | 18.39 | 4.04 |

### Example 4: Microbiologic Analysis

Analyses were performed under strict sterile conditions, to avoid any type of contamination different than the one that could be found in the packaged product. This evaluation was made under a laminar flow cabinet with a burner, in order to maintain the sterility and to avoid potential contamination from the surrounding air. The microorganisms to analyze are indicated in the Chilean Sanitary Regulation for Foods, detailed in Specifications for “pre-made ready for consumption edible fruits and vegetables”. These consider the count of Escherichia coli, Staphylococcus aureus, mesophilic Aerobes (RAM), Enterobacterium, fungus and yeast, as well as Salmonella (table No. 3).

The microbiological analyses were made at 5, 10, 15, 20, 25, and 30 days after packaging and after the breathing measurements of the packaged samples were made, where it was determined the presence or absence or microorganism based on the count of colony forming units (CFU/g). For this assays prickly pears from Til-Til, Melipilla, and Romeral were used. The results shown in table No. 2 were obtained following established parameters. All the assays were done in duplicate. The control for the microorganisms present in pre-made fruits and other edible vegetables corresponds to the contamination limits specified in the Sanitary Regulation of Foods, table No. 3 (RSA, 2010).

TABLE N^{o} 2
Count of colony forming units in peeled and coated prickly pears
measured at 5, 10, 15, 20, 25 y 30 days after its package.

| | | Count (UFC/g) | | | | | | |
|---|---|---|---|---|---|---|---|---|
| | Days | | | | | | Fungus | |
| | stored | Mesophilic | | | Entero- | | and | |
| Source | at 4° C. | Aerobes | Coliforms | E. coli | bacterium | S. aureus | yeast | Salmonella |
| TIL-TIL | 5 | <10 | <10 | <10 | 10 | 50 | 1000 | NEG |
| | 10 | <10 | <10 | <10 | <10 | 20 | 7000 | NEG |
| | 15 | <10 | <10 | <10 | <10 | <10 | | |
| | 20 | 3.2 × 10⁵ | 1.8 × 10³ | <10 | <10 | <10 | <10 | NEG |
| | 25 | 4.3 × 10⁵ | 1.6 × 10³ | <10 | <10 | <10 | <10 | NEG |
| | 30 | 3.6 × 10⁵ | 1.4 × 10³ | <10 | <10 | <10 | <10 | NEG |
| MELIPILLA | 5 | 700 | <10 | <10 | <10 | <10 | 600 | NEG |
| | 10 | 1800 | 900 | <10 | 1100 | 40 | 3.6 × 10⁵ | NEG |
| | 15 | <10 | <10 | <10 | <10 | <10 | | |
| | 20 | 5.7 × 10⁵ | 8.0 × 10⁴ | <10 | 200 | <10 | <10 | NEG |
| | 25 | 3.6 × 10⁵ | 2 × 10³ | <10 | 100 | <10 | <10 | NEG |
| | 30 | 1.3 × 10⁵ | 2.6 × 10³ | <10 | 200 | <10 | <10 | NEG |
| ROMERAL | 5 | 3.4 × 10⁴ | 540 | <10 | 800 | <10 | 400 | NEG |
| | 10 | 100 | 9000 | <10 | <10 | <10 | 2 × 10⁵ | NEG |
| | 15 | 2 × 10⁵ | 5.5 × 10³ | <10 | 8.3 × 10³ | 300 | | |
| | 20 | 2 × 10⁵ | 30 | <10 | <10 | <10 | <10 | NEG |
| | 25 | 1.6 × 10⁵ | 1.6 × 10³ | <10 | <10 | <10 | <10 | NEG |
| | 30 | 4.2 × 10⁵ | <10 | <10 | 3.6 × 10⁴ | <10 | <10 | NEG |

TABLE N^{o} 3
Specifications for the limits of microorganisms presents in pre-made
fruits and other edible consumption ready vegetables.

Limit per gram

| Parameter | m (UFC/g) | M (UFC/g) |
|---|---|---|
| RAM | 5 × 10⁴ | 5 × 10⁵ |
| Enterobacterium | 5 × 10³ | 5 × 10⁴ |
| E. coli | 10 | 102 |
| S. aureus | 10 | 102 |
| Salmonella in 25 g | 0 | — |

m = value of the microbiological parameter at which or under which the food does not represent a risk to the health;
M = value of the microbiologic parameter over which the food represents a risk to the health;

1. A process to obtain edible film coated peeled prickly pears, the process comprising the following steps:
a) removing the thorns from the prickly pears after the harvest;
b) selecting the prickly pears without thorns, discarding the damaged prickly pears;
c) calibrating the selected prickly pears according to size;
d) sanitizing the prickly pear with the peel;
e) peeling the prickly pear;
f) sanitizing the peeled prickly pear;
g) applying a sterile edible coating composition, comprised of hydroxypropyl methylcellulose, glycerol and citric acid over the surface of the peeled prickly pear;
h) externally drying the coated prickly pear;
i) packing the coated and externally dried prickly pear; and
j) keeping the prickly pear under cold in a modified atmosphere.

2. The process of claim 1, wherein removing the thorns is done by rubbing.

3. The process of claim 1, wherein selecting is performed discarding those that are damaged.

4. The process of claim 1, wherein the prickly pears are calibrated by size, homogenizing the volume to maintain a stable industrial process, controlling the amount of prickly pears that enter the process, calculating the necessary supplies needed during the process, so that at the end of said process, the final product is obtained with the same conditions.

5. The process of claim 1, wherein the sanitizing in d) is performed with a 150-200 ppm sodium hypochlorite solution for 2 minutes and the sanitizing in f) is performed with a 200 ppm sodium hypochlorite solution and a solution made of 170 ppm of hypochlorous acid, 25 ppm of hypochlorite ions and 700 ppm of chloride dioxide 700 ppm, for 2 minutes.

6. The process of claim 1, wherein in step e) the prickly pear is peeled in a mechanical or manual form.

7. The process of claim 1, wherein in step g) the sterile edible composition is applied by immersion, aspersion or casting wherein said solution is made of hydroxypropyl methylcellulose (HPMC) in a solution at 2-5% w/v, 0.5-3% w/v glycerol, and 0.5-3% w/v citric acid.

8. The process of claim 1, wherein in the step h) the drying comprises the application of cold and dry air over the fruit under sterile conditions.

9. The process of claim 1, wherein in the step i) the packaging is performed individually in a package with a gas barrier, in a sterile environment, where the normal atmosphere is replaced by a modified atmosphere, by decreasing the content of O₂ to 3-5% and increasing the content of CO₂ to 2-3%.

10. The process of claim 3, wherein in the step j) the packed prickly pear is kept under refrigeration between 2-4° C., in a modified atmosphere over 30 to 45 days.

11. An edible composition to coat a peeled prickly pear, comprising 2-5% w/v hydroxypropyl methylcellulose (HPMC) solution, 0.5-3% w/v glycerol, and 0.5-3 w/v citric acid.

12. The edible composition of claim 11, wherein, once dry, the composition forms a tasteless, odorless and colorless film.

13. Use of an edible composition according to claim 11 to coat peeled prickly pears, thereby delaying the dehydration and decomposition.
